(19) United States
(12) Patent Application Publication
(10) Pub. No.: US 2020/0163111 A1
(43) Pub. Date: May 21, 2020

(54) INFORMATION TRANSMISSION METHOD AND DEVICE

(71) Applicant: Huawei Technologies Co., Ltd., Shenzhen (CN)

(72) Inventors: Zhihu Luo, Beijing (CN); Xiaolei Tie, Shanghai (CN); Zhe Jin, Beijing (CN)

(21) Appl. No.: 16/751,033

(22) Filed: Jan. 23, 2020

Related U.S. Application Data
(63) Continuation of application No. PCT/CN2017/094783, filed on Jul. 27, 2017.

(51) Int. Cl. H04W 72/12

(52) U.S. Cl. CPC H04W 72/1284

(57) ABSTRACT

This application provides an information transmission method and a device. The method includes: obtaining, by a terminal device, resource configuration information, where the resource configuration information is used to indicate a resource used by the terminal device to send a scheduling request; sending, by the terminal device, the scheduling request to a network device on the resource indicated by the resource configuration information, where a preset correspondence exists between a sequence carried in the scheduling request and an amount of uplink data that is requested to be sent by the terminal device to the network device.

### CROSS-REFERENCE TO RELATED APPLICATIONS

This application is a continuation of International Application No. PCT/CN2017/094783, filed on Jul. 27, 2017, the disclosure of which is hereby incorporated by reference in its entirety.

### TECHNICAL FIELD

This application relates to communications technologies, and in particular, to an information transmission method and a device.

### BACKGROUND

The internet of things (IoT) is the “Internet on which things are connected”. To reduce complexity and costs of the internet of things, a mobile communications standardization organization 3GPP (3rd Generation Partnership Project) proposes a narrowband internet of things (NB-IOT) at the RAN#69 meeting.

In NB-IoT, when a terminal device needs to send uplink data, but a base station does not schedule and allocate, for UE, an uplink shared channel (UL-SCH) resource for sending the uplink data, the terminal device may re-initiate random access to obtain the UL-SCH resource. FIG. 1 is a flowchart of initiating random access by a terminal device in the prior art. As shown in FIG. 1, when uplink data arrives at the terminal device, the terminal device sends a random access preamble to a base station, and the base station returns a random access response to the terminal device. The terminal device sends a radio resource control (RRC) connection request to the base station after receiving the random access response. The base station establishes an RRC connection to the terminal device, and the terminal device feeds back hybrid automatic repeat request (HARQ)-acknowledgment (ACK) information to the base station. After the RRC connection is established, each time before receiving downlink data sent by the base station or sending data to the base station, the terminal device needs to listen to a narrowband physical downlink control channel (NPDCCH) to obtain scheduling information related to scheduling of the downlink data or the uplink data.

In the foregoing method, each time a terminal needs to send uplink data, the terminal needs to re-initiate random access. Consequently, a process is complex, and a delay and power consumption are further increased.

### SUMMARY

Embodiments of this application provide an information transmission method and a device. An implementation process is simple, and a delay and power consumption are greatly reduced.

According to a first aspect, an embodiment of this application provides an information transmission method, and the method includes: obtaining, by a terminal device, resource configuration information, where the resource configuration information is used to indicate a resource used by the terminal device to send a scheduling request; and sending, by the terminal device, the scheduling request to a network device on the resource indicated by the resource configuration information, where a preset correspondence exists between a sequence carried in the scheduling request and an amount of uplink data that is requested to be sent by the terminal device to the network device.

According to a second aspect, an embodiment of this application provides an information transmission method, and the method includes: receiving, by a network device, on a resource indicated by resource configuration information, a scheduling request sent by a terminal device, where the resource configuration information is used to indicate the resource used by the terminal device to send the scheduling request, and a preset correspondence exists between a sequence carried in the scheduling request and an amount of uplink data that is requested to be sent by the terminal device to the network device; and determining, by the network device based on the scheduling request, the amount of uplink data that is requested to be sent by the network device.

According to a third aspect, an embodiment of this application provides a terminal device, and the terminal device includes: an obtaining module, configured to obtain resource configuration information, where the resource configuration information is used to indicate a resource used by the terminal device to send a scheduling request; and a sending module, configured to send the scheduling request to a network device on the resource indicated by the resource configuration information, where a preset correspondence exists between a sequence carried in the scheduling request and an amount of uplink data that is requested to be sent by the terminal device to the network device.

According to a fourth aspect, an embodiment of this application provides a network device, and the network device includes: a receiving module, configured to receive, on a resource indicated by resource configuration information, a scheduling request sent by a terminal device, where the resource configuration information is used to indicate the resource used by the terminal device to send the scheduling request, and a preset correspondence exists between a sequence carried in the scheduling request and an amount of uplink data that is requested to be sent by the terminal device to the network device; and a determining module, configured to determine, based on the scheduling request, the amount of uplink data that is requested to be sent by the network device.

In the foregoing embodiment, the terminal device obtains the resource configuration information used to indicate the resource used by the terminal device to send the scheduling request, and sends the scheduling request to the network device on the resource indicated by the resource configuration information. The network device determines, based on the scheduling request, the amount of uplink data that is requested to be sent by the network device, and configures a resource suitable for the amount of uplink data for the terminal device. Because the preset correspondence exists between a sequence carried in the scheduling request and an amount of uplink data that is requested to be sent by the terminal device to the network device, the amount of uplink data that is requested to be sent by the terminal may be determined based on the sequence carried in the scheduling request. In this way, a step of reporting a buffer status report (BSR) can be reduced. A process is simple, and a delay and power consumption are greatly reduced.

In a possible implementation, the scheduling request includes a plurality of symbol groups in time domain, and each symbol group includes a cyclic prefix and at least one symbol.

In the foregoing embodiment, in time domain, different sequences are carried on different symbols or on symbol groups by using a symbol as a granularity, to form different scheduling requests, so as to indicate different amounts of uplink data. This method is simple and has stronger scalability.

In a possible implementation, the scheduling request is transmitted in a single-carrier frequency-hopping manner.

In the foregoing embodiments, the scheduling request is transmitted in a single-carrier frequency-hopping manner. This may avoid mutual interference with a narrowband physical random access channel (NPRACH) preamble signal. In addition, the scheduling request is transmitted in a single-carrier frequency-hopping manner, so that a configuration manner of a resource used to send the scheduling request is more flexible.

In a possible implementation, sequences carried on different symbol groups of the scheduling request are different, and sequences carried on different symbols in a same symbol group are the same.

In the foregoing embodiment, sequences carried on different symbol groups of the scheduling request are different, and sequences carried on different symbols in a same symbol group are the same. Different sequences are carried on different symbol groups to indicate different amounts of uplink data. In this way, a step of separately reporting a BSR can be avoided. A process is simple, and a delay and power consumption are greatly reduced.

In a possible implementation, the scheduling request is transmitted in a single-carrier manner, all symbol groups in a repeated sending period of the scheduling request are located at a same subcarrier location, and a sending period of the scheduling request includes at least one repeated sending period.

In the foregoing embodiment, in frequency domain, different sequences are carried by using a symbol as a granularity to form different scheduling requests, and the scheduling requests are transmitted in a single-carrier manner. In addition, a plurality of symbol groups in a repeated sending period of the scheduling request are located at a same subcarrier location. Therefore, a longer sequence can be formed, a code resource is richer, and a granularity of the amount of uplink data is finer.

In a possible implementation, sequences carried on different symbol groups of the scheduling request are different, and sequences carried on different symbols in a same symbol group are different.

In the foregoing solution, sequences carried on different symbol groups of scheduling request are different, and sequences carried on different symbols in a same symbol group are also different, so that a more refined scheduling request may be formed, so as to indicate more types of amounts of uplink data. Therefore, a resource allocated by the network device to the terminal device for sending uplink data is more accurate, and proper utilization of the resource is ensured.

In a possible implementation, before the sending, by the terminal device, the scheduling request to a network device on the resource indicated by the resource configuration information, the method further includes: performing timing advance TA adjustment.

In the foregoing solution, the terminal device performs the timing advance adjustment before sending the scheduling request. The timing advance adjustment is to ensure orthogonality of uplink transmission, so that times at which signals that are of different terminal devices and that arrive in a same subframe arrive at the network device is the same or a time difference between times at which signals arrive at the network device falls within a range of a cyclic prefix, to avoid intra-cell interference.

In a possible implementation, the resource indicated by the resource configuration information includes all frequency domain resources used to transmit a narrowband physical random access channel NPRACH; or the resource indicated by the resource configuration information includes a subset of all frequency domain resources used to transmit a narrowband physical random access channel NPRACH; or the resource indicated by the resource configuration information includes a frequency domain resource, other than a frequency domain resource used for contention-based random access in frequency domain resources used to transmit an NPRACH; or the resource indicated by the resource configuration information includes a subset of a frequency domain resource, other than a frequency domain resource used for contention-based random access in frequency domain resources used to transmit an NPRACH; or the resource indicated by the resource configuration information includes a frequency-hopping resource, other than resource whose quantity is an integer multiple of a quantity of resources in an NPRACH frequency-hopping range in all frequency domain resources used to transmit an NPRACH.

In a possible implementation, in the first aspect, the obtaining, by a terminal device, resource configuration information includes: receiving, by the terminal device, the resource configuration information sent by the network device; or obtaining, by the terminal device, the resource configuration information from a local cache, where the resource configuration information is configured by the network device for the terminal device when the terminal device is initialized.

In the foregoing embodiment, the network device may deliver the resource configuration information each time the terminal device needs to send a scheduling request, or the network device may periodically send the resource configuration information to the terminal device. Alternatively, the network device configures the resource configuration information for the terminal device when the terminal device is initialized. The terminal device stores the resource configuration information in a local cache, and obtains the resource configuration information from the local cache when the terminal device needs to send a scheduling request. A manner of obtaining the resource configuration information is relatively flexible, so that reliability of obtaining the resource configuration information by the terminal device is ensured.

In a possible implementation, in the second aspect or the fourth aspect, the resource configuration information is sent by the network device to the terminal device; or the resource configuration information is configured by the network device for the terminal device when the terminal device is initialized.

In the foregoing embodiment, the network device may deliver the resource configuration information each time the terminal device needs to send a scheduling request, or the network device configures the resource configuration information for the terminal device when the terminal device is initialized. The terminal device stores the resource configuration information in a local cache, and obtains the resource configuration information form the local cache when the terminal device needs to send a scheduling request. A manner of obtaining the resource configuration information is relatively flexible, so that reliability of obtaining the resource configuration information by the terminal device is ensured.

In a possible implementation, in the third aspect, the obtaining module is specifically configured to: receive the resource configuration information sent by the network device; or obtain the resource configuration information from a local cache, where the resource configuration information is configured by the network device for the terminal device when the terminal device is initialized.

In the foregoing embodiment, the obtaining module may receive the resource configuration information sent by the network device each time the terminal device needs to send a scheduling request, or the obtaining module may periodically receive the resource configuration information sent by the network device. Alternatively, the network device configures the resource configuration information for the terminal device when the terminal device is initialized. The terminal device stores the resource configuration information in a local cache, and obtains the resource configuration information from the local cache when the terminal device needs to send a scheduling request. A manner of obtaining the resource configuration information by the obtaining module is relatively flexible, so that reliability of obtaining the resource configuration information by the terminal device is ensured.

In the foregoing solutions, a configuration manner of a resource used to send a scheduling request is flexible. In this way, a frequency domain resource can be properly used, and mutual interference between NPRACH transmission signals can be avoided.

A fifth aspect of this application provides a terminal device, including at least one processing component (or chip) configured to perform the method in the first aspect or all implementations of the first aspect.

A sixth aspect of this application provides a network device, including at least one processing component (or chip) configured to perform the method in the second aspect or all implementations of the second aspect.

A seventh aspect of this application provides a readable storage medium, and the readable storage medium stores an executable instruction. When at least one processor of a terminal device executes the executable instruction, the terminal device performs the information transmission method provided in the first aspect or all implementations of the first aspect.

An eighth aspect of this application provides a readable storage medium, and the readable storage medium stores an executable instruction. When at least one processor of a network device executes the executable instruction, the network device performs the information transmission method provided in the second aspect or all implementations of the second aspect.

A ninth aspect of this application provides a program product. The program product includes an executable instruction, and the executable instruction is stored in a readable storage medium. At least one processor of a terminal device may read the executable instruction from the readable storage medium, and the at least one processor executes the executable instruction to enable the terminal device to perform the information transmission method provided in the first aspect or all implementations of the first aspect.

A tenth aspect of this application provides a program product. The program product includes an executable instruction, and the executable instruction is stored in a readable storage medium. At least one processor of a network device may read the executable instruction from the readable storage medium, and the at least one processor executes the executable instruction to enable the network device to perform the information transmission method provided in the second aspect or all implementations of the second aspect.

An eleventh aspect of this application provides a network system, and the network system includes the terminal device and the network device in the foregoing aspects.

### BRIEF DESCRIPTION OF THE DRAWINGS

FIG. 1 is a flowchart of initiating random access by a terminal device in the prior art;

FIG. 2 is a schematic diagram of an application scenario of an information transmission method according to an embodiment of this application;

FIG. 3 is a flowchart of an information transmission method according to an embodiment of this application;

FIG. 4 is a schematic diagram of a signal format of a scheduling request according to an embodiment of this application;

FIG. 5 is a schematic diagram of a symbol group format according to an embodiment of this application;

FIG. 6 is a schematic diagram of a signal format of a scheduling request according to an embodiment of this application;

FIG. 7 is a schematic diagram of a signal format of a scheduling request according to an embodiment of this application;

FIG. 8 is a schematic diagram of another signal format of a scheduling request according to an embodiment of this application;

FIG. 9 is a block diagram of a terminal device according to an embodiment of this application;

FIG. 10 is a block diagram of a network device according to an embodiment of this application; and

FIG. 11 is a block diagram of a terminal device according to an embodiment of this application.

### DETAILED DESCRIPTION OF ILLUSTRATIVE EMBODIMENTS

An information transmission method provided in the embodiments of this application is mainly applied to a wireless communications system such as a long term evolution (LTE) system, a long term evolution-advanced LTE-A (LTE Advanced) system, or NB-IOT. There are an entity that may send information and an entity that may receive information in the wireless communications system. The information transmission method may also be applied to another communications system, for example, a mobile communications systems such as a new radio (NR) system, a global system for mobile communications (GSM) system, a code division multiple access (CDMA) system, a wideband code division multiple access (WCDMA) system, a general packet radio service (GPRS), a long term evolution (LTE) system, a long term evolution-advanced (Advanced long term evolution, LTE-A) system, a universal mobile telecommunications system (UMTS), an evolved long term evolution (eLTE) system, or 5G.

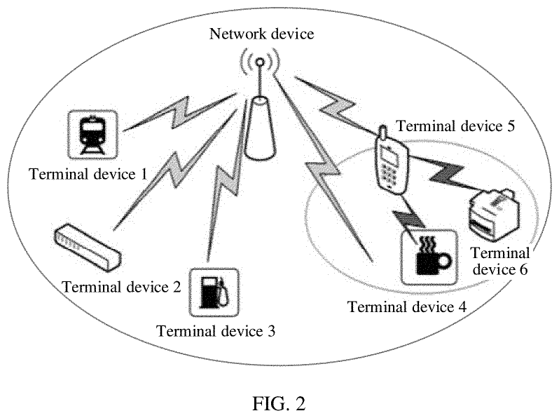

FIG. 2 is a schematic diagram of an application scenario of an information transmission method according to an embodiment of this application. As shown in FIG. 2, a network device and a terminal device 1 to a terminal device 6 form a communications system. In the communications system, a base station sends information to one or more terminal devices in the terminal device 1 to the terminal device 6. In addition, a terminal device 4 to the terminal device 6 also form a communications system. In the communications system, a terminal device 5 may send information to the terminal device 4, the terminal device 6, or both the terminal device 4 and the terminal device 6. The network device may be a common base station (for example, a Node B or an eNB), a new radio controller (NR controller), a gNode B (gNB) in a 5G system, a centralized network element (Centralized Unit), a new radio base station, a remote radio unit, a micro base station, a relay, a distributed network element (Distributed Unit), a reception point (Transmission Reception Point, TRP), a transmission point (TP), or any other radio access device. However, this is not limited in this embodiment of this application. The terminal device is also referred to as user equipment (UE), and is a device that provides a user with voice and/or data connectivity, for example, a handheld device or a vehicle-mounted device that has a wireless connection function. Common terminals include a mobile phone, a tablet, a notebook computer, a palmtop computer, a mobile Internet device (MID), and a wearable device, such as a smartwatch, a smart band, or a pedometer.

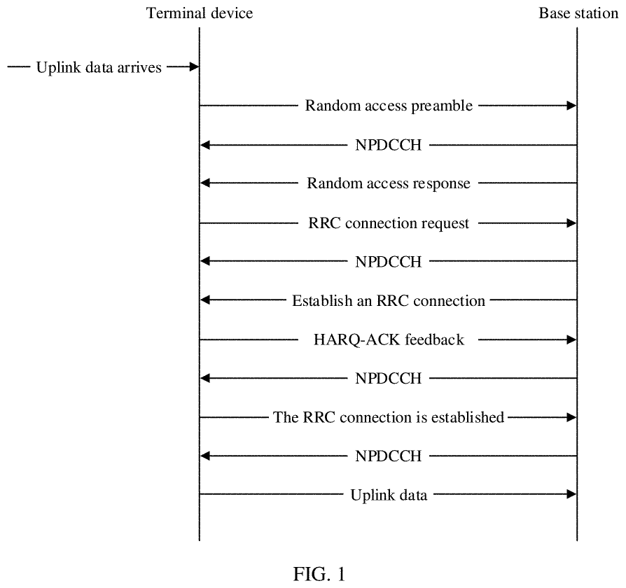

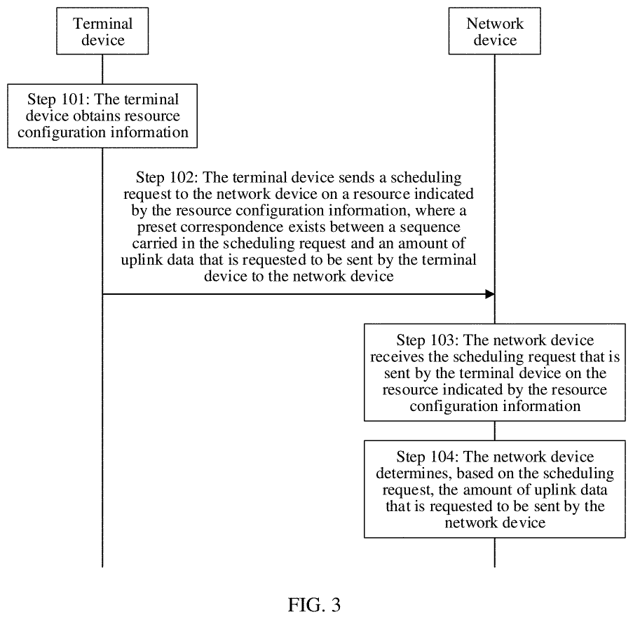

FIG. 3 is a flowchart of an information transmission method according to an embodiment of this application. As shown in FIG. 1, an application scenario of the method includes a terminal device and a network device. The method includes the following steps.

Step 101: The terminal device obtains resource configuration information.

The resource configuration information is used to indicate a resource used by the terminal device to send the scheduling request.

For example, the resource configuration information may include a subcarrier index, a carrier index, a quantity of repetition times, a period, a starting subframe location, and the like; or the resource configuration information may include an index jointly indicated by configuration parameters such as a subcarrier index, a carrier index, a quantity of repetition times, a period, and a starting subframe location.

For example, the resource indicated by the resource configuration information includes all frequency domain resources used to transmit a narrowband physical random access channel (NPRACH); or includes a subset of all frequency domain resources used to transmit an NPRACH; or includes a frequency domain resource other than a frequency domain resource used for contention-based random access in frequency domain resources used to transmit an NPRACH; or includes a subset of a frequency domain resource other than a frequency domain resource used for contention-based random access in frequency domain resources used to transmit an NPRACH; or includes a frequency-hopping resource other than resources whose quantity is an integer multiple of a quantity of resources in an NPRACH frequency-hopping range in all frequency domain resources used to transmit an NPRACH.

For example, that the terminal device obtains resource configuration information may include: The terminal device receives the resource configuration information sent by the network device; or the terminal device obtains the resource configuration information from a local cache. The resource configuration information is configured by the network device when the terminal device is initiated.

For example, the network device may deliver the resource configuration information each time the terminal device needs to send the scheduling request.

For example, the network device may periodically send the resource configuration information to the terminal device.

For example, the network device configures the resource configuration information when the terminal device is initialized. The terminal device stores the resource configuration information in the local cache, and obtains the resource configuration information from the local cache when the terminal device needs to send the scheduling request. A manner of obtaining the resource configuration information is relatively flexible. Herein, that the terminal device is initialized means that the terminal device is powered on, the terminal device establishes an RRC connection, the terminal device re-establishes an RRC connection, the terminal device performs RRC reconfiguration, or the like.

In this embodiment, the network device may deliver the resource configuration information each time the terminal device needs to send the scheduling request, or the network device may periodically send the resource configuration information to the terminal device. Alternatively, the network device configures the resource configuration information when the terminal device is initialized. The terminal device stores the resource configuration information in the local cache, and obtains the resource configuration information from the local cache when the terminal device needs to send the scheduling request. A manner of obtaining the resource configuration information is relatively flexible, so that reliability of obtaining the resource configuration information by the terminal device is ensured.

Step 102: The terminal device sends the scheduling request to the network device on the resource indicated by the resource configuration information, where a preset correspondence exists between a sequence carried in the scheduling request and an amount of uplink data that is requested to be sent by the terminal device to the network device.

For example, in this embodiment, the preset correspondence between a sequence carried in the scheduling request and an amount of uplink data that is requested to be sent by the terminal device to the network device may be pre-established. There may be a one-to-one correspondence or a one-to-many correspondence between the sequence carried in the scheduling request and the amount of uplink data that is requested to be sent by the terminal device to the network device.

For example, one sequence may correspond to one fixed amount of uplink data, or one sequence may correspond to one group of amounts of uplink data, or one sequence may correspond to one range of an amount of uplink data. A person skilled in the art may set, based on an actual situation, the preset correspondence between a sequence carried in the scheduling request and an amount of uplink data that is requested to be sent by the terminal device to the network device. This is not limited in this application.

For example, when uplink data arrives and there is no available UL-SCH resource, the sequence carried in the scheduling request is determined based on the correspondence between a sequence carried in the scheduling request and an amount of uplink data that is requested to be sent by the terminal device to the network device, and the scheduling request is sent on a resource allocated by the network device.

For example, the terminal device performs timing advance adjustment before sending the scheduling request. The timing advance adjustment is to ensure orthogonality of uplink transmission, so that times at which signals that are of different terminal devices and that arrive in a same subframe arrive at the network device is the same or a time difference between times at which signals arrive at the network device falls within a range of a cyclic prefix, to avoid intra-cell interference. A process of timing advance adjustment herein is the same as that in the prior art. The terminal device determines a timing advance based on a timing advance command sent by the network device, and uses the timing advance when sending uplink data.

Step 103: The network device receives the scheduling request that is sent by the terminal device on the resource indicated by the resource configuration information.

Step 104: The network device determines, based on the scheduling request, the amount of uplink data that is requested to be sent by the network device.

For example, the network device detects, on an allocated resource, whether a scheduling request is reported; obtains, based on a sequence carried in a detected scheduling request, information about an amount that is of uplink data and that needs to be reported by the terminal device; and sends scheduling information to the terminal device. The scheduling information is used to indicate a resource used by the terminal device to send uplink data. After receiving the scheduling information sent by the network device, the terminal device sends uplink data to the network device at a resource location indicated by the scheduling information.

For example, in this embodiment, the resource configuration information, the resource indicated by the resource configuration information, and the scheduling request in step 103 and step 104 are the same as the resource configuration information, the resource indicated the resource configuration information, and the scheduling request in step 101 and step 102. Details are not described herein again.

According to the information transmission method provided in this embodiment of this application, the terminal device obtains the resource configuration information used to indicate the resource used by the terminal device to send the scheduling request, and sends the scheduling request to the network device on the resource indicated by the resource configuration information. The network device determines, based on the scheduling request, the amount of uplink data that is requested to be sent by the network device, and configures a resource suitable for the amount of uplink data for the terminal device. Because the preset correspondence exists between the sequence carried in the scheduling request and the amount of uplink data that is requested to be sent by the terminal device to the network device, the amount of uplink data that is requested to be sent by the terminal may be determined based on the sequence carried in the scheduling request. In this way, a step of reporting a BSR (buffer status report) can be reduced. A process is simple, and a delay and power consumption are greatly reduced.

For example, based on the embodiment shown in FIG. 3, the scheduling request includes a plurality of symbol groups in time domain, and each symbol group includes a cyclic prefix and a plurality of symbols.

In this embodiment, different scheduling requests are formed by using a symbol as a granularity in time domain, setting different quantity of symbols, and adding different sequences to different symbols, so as to indicate different amounts of uplink data. This method is simple and has stronger scalability.

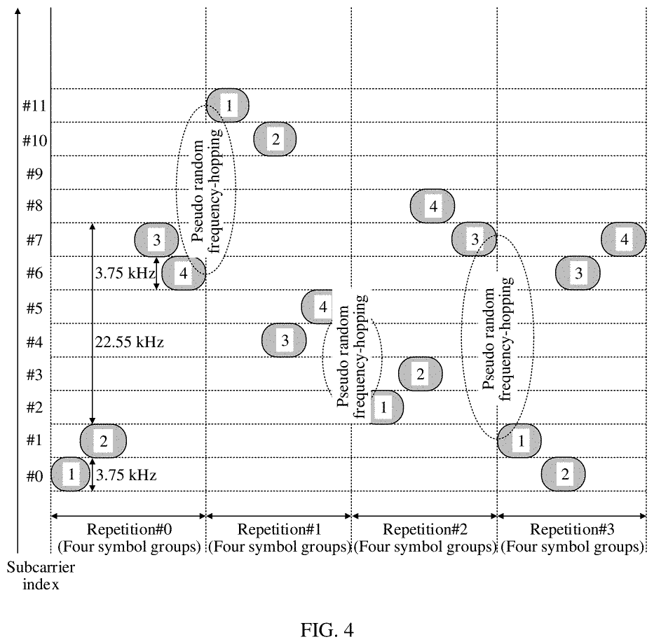

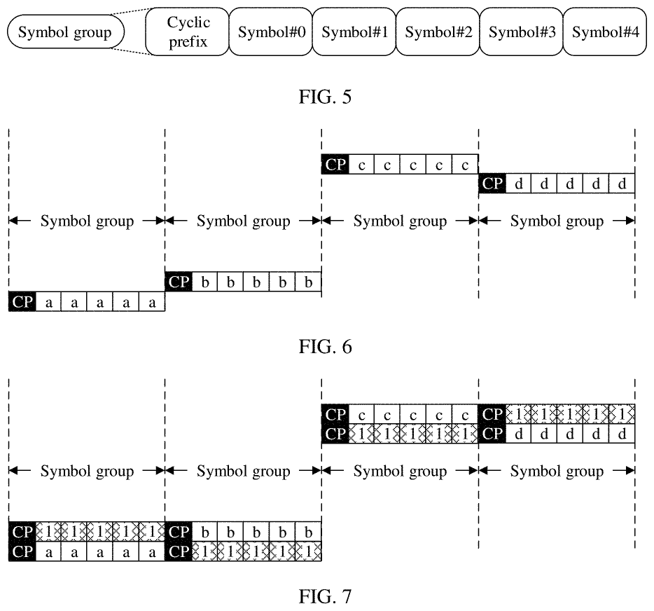

FIG. 4 is a schematic diagram of a signal format of a scheduling request according to an embodiment of this application. FIG. 5 is a schematic diagram of a symbol group format according to an embodiment of this application. In this embodiment, the signal format of the scheduling request may use a design of an NPRACH preamble, or may use another format different from a signal format of the NPRACH preamble. This is not limited in this application. As shown in FIG. 4 and FIG. 5, one scheduling request includes four symbol groups, and each symbol group includes a cyclic prefix and a plurality of symbols.

For example, in the embodiment shown in FIG. 4, the scheduling request is transmitted in a single-carrier frequency-hopping manner. A frequency domain location for transmitting the scheduling request may be limited to 12 subcarriers, and a frequency-hopping range of frequency domain is 12 subcarriers. As shown in FIG. 4, #0 to #11 indicate 12 subcarriers. One carrier bandwidth is 180 kHz, one scheduling request occupies one subcarrier, and a subcarrier bandwidth is 3.75 kHz. Therefore, one carrier may support a maximum of 180/3.75=48 scheduling requests. As shown in FIG. 4, symbol groups of the scheduling request in each repetition period in the figure are represented by gray-filled rectangles and numbers, and are denoted as a first symbol group, a second symbol group, a third symbol group, and a fourth symbol group in a time sequence, which are respectively represented by using numbers 1, 2, 3, and 4 in the figure. The scheduling request has two types of frequency-hopping intervals in one repetition period: 3.75 kHz and 22.5 kHz. The frequency-hopping interval is an integer multiple of a subcarrier bandwidth, and a minimum frequency-hopping interval and the subcarrier bandwidth are the same. A frequency-hopping interval between the first symbol group and the second symbol group is 3.75 kHz, and a frequency-hopping interval between the third symbol group and the fourth symbol group is 3.75 kHz. A frequency-hopping interval between the second symbol group and the third symbol group is 22.5 kHz. Pseudo random frequency-hopping is used between two time-continuous repetition periods. A frequency-hopping interval between the two repetition periods is determined based on a pseudo random sequence, and an initialization seed of the pseudo random sequence is a cell identity or a function of a cell identity.

In this embodiment, the scheduling request is transmitted in a single-carrier frequency-hopping manner. This may avoid mutual interference between narrowband physical random access channel (NPRACH) preamble signals. In addition, the scheduling request is transmitted in a single-carrier frequency-hopping manner, so that a configuration manner of a resource used to send the scheduling request is more flexible.

It should be noted that in an actual implementation process, a person skilled in the art may set, based on an actual requirement, a frequency domain location for transmitting the scheduling request. The frequency domain location is not limited to 12 subcarriers. FIG. 4 is merely an example for description, and is not intended to constitute any limitation on the solutions of this application.

For example, in this embodiment, sequences carried on different symbol groups of the scheduling request are different, and sequences carried on different symbols in a same symbol group are the same.

In this embodiment, the signal format of the scheduling request may reuse the design of the NPRACH preamble, to be specific, the scheduling request also uses a single-carrier frequency-hopping manner, and a frequency-hopping pattern is the same as an NPRACH preamble manner. A subcarrier bandwidth, a quantity of symbol groups, a length of a cyclic prefix and a length of a symbol that are in a symbol group, and a quantity of symbols are the same as those of the NPRACH preamble. A difference lies in that a sequence carried on each symbol of the NPRACH preamble is 1, and sequences carried on symbols in different symbol groups are 1. However, in this embodiment of this application, sequences carried on different symbol groups of the scheduling request are different, sequences carried on different symbols in a same symbol group are the same, and different sequences carried on different symbol groups are used to indicate different amounts of uplink data.

In this embodiment, sequences carried on different symbol groups of the scheduling request are different, and sequences carried on different symbols in a same symbol group are the same. Different sequences are carried on different symbol groups to indicate different amounts of uplink data. In this way, a step of separately reporting a BSR can be avoided. A process is simple, and a delay and power consumption are greatly reduced.

FIG. 6 is a schematic diagram of a signal format of a scheduling request according to an embodiment of this application. As shown in FIG. 6, sequences carried on different symbol groups of the scheduling request are different. Sequences carried in the scheduling request are {a, b, c, d}, and a, b, c, and d are respectively carried on different symbol groups. Sequences carried on symbols in each symbol group are the same, and different sequences correspond to different amounts of uplink data.

For example, a sequence carried in the scheduling request may be a Walsh sequence, which may also be referred to as Walsh code. For example, for a case in FIG. 6, a Walsh sequence with a length of 4 may be selected. Table 1 shows a correspondence between a sequence carried in the scheduling request and an uplink quantity. As shown in Table 1, there are four Walsh sequences with a length of 4, and a maximum of four Walsh sequences may be used to carry information about a 2-bit amount of uplink data. BSR_0, BSR_1, BSR_2, and BSR_3 respectively represent four types of different amounts of uplink data. For example, BSR_0 is X0 bytes, BSR_1 is X1 bytes, BSR_2 is X2 bytes, and BSR_3 is X3 bytes; and X_0<X1 <X2<X3. Alternatively, BSR_0, BSR_1, BSR_2, and BSR_3 respectively represent different ranges of an amount of uplink data. For example, YOO bytes≤BSR_0<Y01 bytes, Y10 bytes≤BSR_1<Y11 bytes, Y20 bytes≤BSR_2<Y21 bytes, and Y30 bytes≤BSR_2<Y31 bytes; and Y00≤Y01<Y10<Y11<Y20<Y21<Y30<Y31. Specifically, there may be no upper limit Y31.

TABLE 1

| | a | b | c | d |
|---|---|---|---|---|
| BSR_0 | 1 | 1 | 1 | 1 |
| BSR_1 | 1 | −1 | 1 | −1 |
| BSR_2 | 1 | 1 | −1 | −1 |
| BSR_3 | 1 | −1 | −1 | 1 |

Considering effect of a frequency offset, coherent combination cannot be performed on four symbol groups. Some Walsh sequences may be selected to carry information about a 1-bit amount of uplink data. Table 2 and Table 3 respectively represent another correspondence between a sequence carried in the scheduling request and an uplink quantity. BSR_I and BSR_II respectively represent two different types of amounts of uplink data, for example, BSR_I is Z0 bytes, and BSR_II is Z1 bytes; and Z0<Z1. Alternatively, BSR_I and BSR_II respectively represent different ranges of the amount of uplink data, for example, W00 bytes≤BSR_I<W01 bytes, and W10 bytes≤BSR_II<W11 bytes; and W00≤W01<W10<W11. Specially, there may be no upper limit W11.

TABLE 2

| | a | b | c | d |
|---|---|---|---|---|
| BSR_I | 1 | 1 | 1 | 1 |
| BSR_II | 1 | −1 | 1 | −1 |

TABLE 3

| | a | b | c | d |
|---|---|---|---|---|
| BSR_I | 1 | 1 | 1 | 1 |
| BSR_II | 1 | −1 | −1 | 1 |

In this embodiment, the scheduling request has two formats that respectively correspond to two cyclic prefix (CP) lengths. Table 4 shows the two formats of the scheduling request. TCP is a length of a cyclic prefix, and TSEQ is total duration of five symbols in each symbol group. FIG. 4 is merely an example.

TABLE 4

| Scheduling request | | | Maximum cell |
|---|---|---|---|
| format | TCP (μs) | TSEQ (μs) | radius (km) |
| 0 | 66.7 | 5 × 266.67 | 10 |
| 1 | 266.67 | 5 × 266.67 | 40 |

In addition, in this embodiment of this application, a quantity of symbol groups in one repetition period is 4, and a case in which more symbol groups are supported in subsequent evolution is not excluded. Therefore, the quantity of symbol groups is not limited in this application. For example, if the quantity of symbol groups is 8, a sequence carried on each symbol group of the scheduling request may be a Walsh sequence with a length of 8, and may carry information about a maximum of a 3-bit amount of uplink data.

In this embodiment, the signal format of the scheduling request reuses a design of an NPRACH preamble, and is naturally compatible with an NPRACH, so that resource configuration of the scheduling request is more flexible. As shown in FIG. 7, a symbol of the NPRACH preamble is filled with a grid, and a symbol of the scheduling request is not filled. In addition, different sequences are carried by using a symbol group as a granularity to indicate different amounts of uplink data, so as to avoid generating inter-subcarrier interference to the NPRACH.

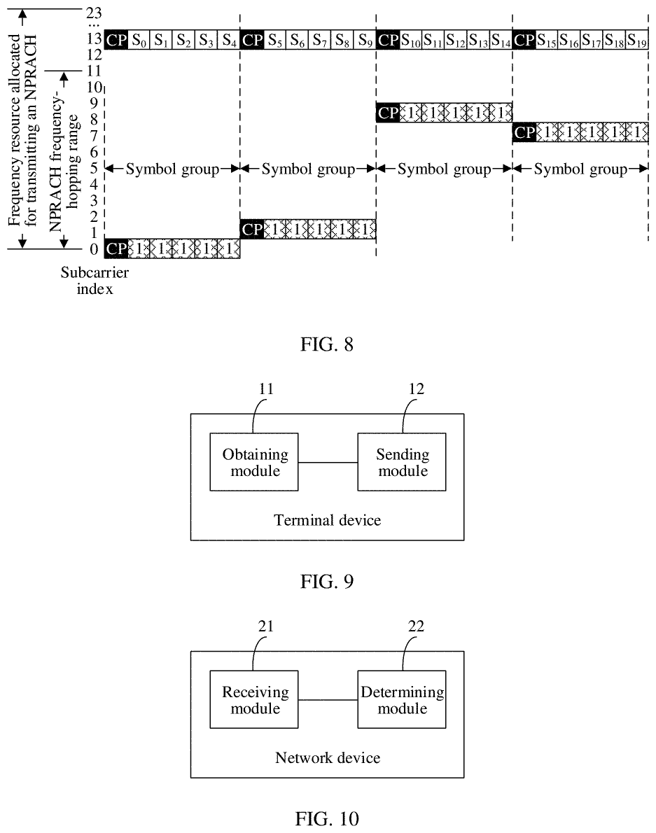

FIG. 8 is a schematic diagram of another signal format of a scheduling request according to an embodiment of this application. For example, as shown in FIG. 8, the scheduling request is transmitted in a single-carrier manner, a plurality of symbol groups in a repeated sending period of the scheduling request are located at a same subcarrier location, and a sending period of the scheduling request includes a plurality of repeated sending periods.

In this embodiment, the sending period of the scheduling request includes the plurality of repeated sending periods. The sending period of the scheduling request may be determined based on a parameter period in the resource configuration information, and a quantity of the repeated sending periods in the sending period may be determined based on a quantity of repetition times in the resource configuration information. A plurality of symbol groups in the repeated sending period of the scheduling request are located at a same subcarrier location, and the plurality of symbol groups of the scheduling request may be located at a same subcarrier location or may be located at different subcarrier locations in different repeated sending periods. For example, in a scenario, one sending period is divided into a repeated sending period a, a repeated sending period b, and a repeated sending period c. Subcarrier locations corresponding to different symbol groups in each repeated sending period are the same, and symbol groups between the repeated sending period a, the repeated sending period b, and the repeated sending period c may be located at a same subcarrier location or may be located at different subcarrier locations. Specially, to better randomize inter-cell interference, a change of subcarrier locations of symbol groups in different repetition periods of the scheduling request is determined based on a pseudo random sequence. The pseudo random sequence may be an m sequence, an M sequence, a gold sequence, or the like. A pseudo random sequence seed is a cell identifier or a function of a cell identifier.

In this embodiment, in frequency domain, different sequences are carried by using a symbol as a granularity to form different scheduling requests, and the scheduling requests are transmitted in a single-carrier manner. In addition, a plurality of symbol groups in a repeated sending period of the scheduling request are located at a same subcarrier location. Therefore, a longer sequence can be formed, a code resource is richer, and a granularity of an amount of uplink data is finer.

For example, in this embodiment, sequences carried on different symbol groups of the scheduling request are different, and sequences carried on different symbols in a same symbol group are different.

In this embodiment, the signal format of the scheduling request reuses a design of an NPRACH preamble, but a frequency-hopping design is removed. To be specific, a single-carrier manner is used. A subcarrier bandwidth, a quantity of symbol groups, a length of the CP and a length of a symbol in a symbol group, and a quantity of symbols that are of the scheduling request are the same as those of the NPRACH preamble. A sequence carried on each symbol of the NPRACH preamble is 1, and sequences carried on symbols in different symbol groups are 1.

In this embodiment, sequences carried on different symbol groups of the scheduling request are different, and sequences carried on different symbols in a same symbol group are also different, so that a more refined scheduling request may be formed, to indicate a plurality of types of amounts of uplink data. Therefore, a resource allocated by a network device to a terminal device for sending uplink data is more accurate, and proper utilization of the resource is ensured.

In this embodiment, to avoid the scheduling request from interfering in transmitting an NPRACH preamble, all frequency domain resources allocated for transmitting the NPRACH preamble may be used to transmit the scheduling request; or the scheduling request may be transmitted on a resource, other than resources whose quantity is an integer multiple of resources in an NPRACH frequency-hopping range in all frequency domain resources allocated for transmitting an NPRACH preamble. As shown in FIG. 8, a symbol of the NPRACH preamble is filled with a grid, and a symbol of the scheduling request is not filled. In one carrier, a frequency domain resource allocated for transmitting the NPRACH preamble is 24 subcarriers, and a frequency-hopping range of an NPRACH is 12 subcarriers. A subcarrier 0 to a subcarrier 11 are used to transmit the NPRACH preamble, and a subcarrier 12 to a subcarrier 23 may be used to transmit the scheduling request.

In this embodiment, a sequence carried in the scheduling request may be an m sequence, an M sequence, a ZC sequence, a Walsh sequence, or the like. For example, in the scenario shown in FIG. 8, a ZC sequence with a length of 20 may be selected. ZC sequences with different root factors, or ZC sequences with same root factors but different cyclic shifts, or ZC sequences with different root factors and different cyclic shifts separately represent different information about an amount of uplink data. For example, a formula

$${s}_{n} = {e}^{- j \frac{π un ( n + 1 )}{20}}$$

is used to calculate a sequence carried on each symbol; and in the formula, n represents an index, n=0, 1, . . . , 19, u represents a root factor, and a value range of u is 1, 2, . . . , 19. Therefore, if the ZC sequences with different roots are used to form the scheduling request, the ZC sequence may carry information about a maximum of a 4 bit amount of uplink data.

According to the information transmission method provided in this embodiment of this application, different sequences are carried on different symbols to indicate different amounts of uplink data, so that a delay and power consumption can be further reduced. In addition, different sequences are carried by using a symbol as a granularity to form different scheduling requests. Therefore, a longer sequence can be used, a code resource is richer, and a granularity of an amount of uplink data can be finer.

FIG. 9 is a block diagram of a terminal device according to an embodiment of this application. The terminal device may be configured to perform the technical solutions on a terminal device side in any one of the foregoing method embodiments. As shown in FIG. 9, the terminal device includes an obtaining module 11 and a sending module 12.

The obtaining module 11 is configured to obtain the resource configuration information, and the resource configuration information is used to indicate a resource used by the terminal device to send the scheduling request. The sending module 12 is configured to send the scheduling request to a network device on the resource indicated by the resource configuration information obtained by the obtaining module 11, and a preset correspondence exists between a sequence carried in the scheduling request and an amount of uplink data that is requested to be sent by the terminal device to the network device.

For example, the scheduling request includes a plurality of symbol groups in time domain, and each symbol group includes a cyclic prefix and at least one symbol.

For example, the scheduling request is transmitted in a single-carrier frequency-hopping manner.

For example, sequences carried on different symbol groups of the scheduling request are different, and sequences carried on different symbols in a same symbol group are the same.

For example, the scheduling request is transmitted in a single-carrier manner, a plurality of symbol groups in a repeated sending period of the scheduling request are located at a same subcarrier location, and a sending period of the scheduling request includes a plurality of repeated sending periods.

For example, sequences carried on different symbol groups of the scheduling request are different, and sequences carried on different symbols in a same symbol group are different.

For example, the obtaining module 11 is specifically configured to receive the resource configuration information sent by the network device, or obtain the resource configuration information from a local cache. The resource configuration information is configured by the network device for the terminal device when the terminal device is initialized.

FIG. 10 is a block diagram of a network device according to an embodiment of this application. The network device may be configured to perform the technical solutions on a network device side in any one of the foregoing method embodiments. As shown in FIG. 10, the network device includes a receiving module 21 and a determining module 22. The receiving module 21 is configured to receive, on a resource indicated by the resource configuration information, the scheduling request sent by the terminal device. The resource configuration information is used to indicate the resource used by the terminal device to send the scheduling request, and a preset correspondence exists between a sequence carried in the scheduling request and an amount of uplink data that is requested to be sent by the terminal device to the network device. The determining module 22 is configured to determine, based on the scheduling request received by the receiving module 21, the amount of uplink data that is requested to be sent by the network device.

For example, the scheduling request includes a plurality of symbol groups in time domain, and each symbol group includes a cyclic prefix and a plurality of symbols.

For example, the scheduling request is transmitted in a single-carrier frequency-hopping manner.

For example, sequences carried on different symbol groups of the scheduling request are different, and sequences carried on different symbols in a same symbol group are the same.

For example, the scheduling request is transmitted in a single-carrier manner, a plurality of symbol groups in a repeated sending period of the scheduling request are located at a same subcarrier location, and a sending period of the scheduling request includes at least one repeated sending period.

For example, sequences carried on different symbol groups of the scheduling request are different, and sequences carried on different symbols in a same symbol group are different.

For example, the resource configuration information is sent by the network device to the terminal device. Alternatively, the resource configuration information is obtained by the terminal device from a local cache, and the resource configuration information is configured by the network device for the terminal device when the terminal device is initialized.

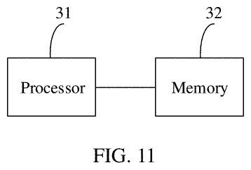

FIG. 11 is a block diagram of a terminal device according to an embodiment of this application. As shown in FIG. 11, the terminal device includes a processor 31 and a memory 32. The memory 32 is configured to store an instruction, and the processor 31 is configured to execute the instruction stored in the memory 32. When the processor 31 executes the instruction stored in the memory 32, the terminal device is configured to perform the method on a terminal device side in any one of the foregoing embodiments.

For example, an embodiment of this application further provides a network device. A structural block diagram of the network device is the same as a structure in FIG. 11. The network device includes a processor 31 and a memory 32. The memory 32 is configured to store an instruction, and the processor 31 is configured to execute the instruction stored in the memory 32. When the processor 31 executes the instruction stored in the memory 32, the network device is configured to perform the method on a network device side in any one of the foregoing embodiments.

This application further provides a readable storage medium, and the readable storage medium stores an instruction. When at least one processor of a terminal device executes the instruction, the terminal device performs the information transmission method provided in any one of the foregoing method embodiments.

This application further provides a readable storage medium, and the readable storage medium stores an instruction. When at least one processor of a network device executes the instruction, the network device performs the information transmission method provided in any one of the foregoing method embodiments.

This application further provides a program product. The program product includes an instruction, and the instruction is stored in a readable storage medium. At least one processor of a terminal device may read the instruction from the readable storage medium, and execute the instruction, to enable the terminal device to perform the information transmission method provided in any one of the method embodiments.

This application further provides a program product. The program product includes an instruction, and the instruction is stored in a readable storage medium. At least one processor of a network device may read the instruction from the readable storage medium, and execute the instruction, to enable the network device to perform the information transmission method provided in any one of the foregoing method embodiments.

This application further provides a network system, and the network system includes the terminal device and the network device in any one of the foregoing embodiments.

In a specific implementation of the terminal device or the network device, it should be understood that a processor may be a central processing unit (CPU for short), or may be another general purpose processor, a digital signal processor (DSP for short), an application-specific integrated circuit (ASIC for short), or the like. The general purpose processor may be a microprocessor, or the processor may be any conventional processor or the like. The steps of the methods disclosed with reference to this application may be directly performed by a hardware processor, or may be performed by a combination of hardware and a software module in the processor.

All or some of the steps of the foregoing method embodiments may be performed by hardware related to a program instruction. The foregoing program may be stored in a readable memory. When the program is executed, the steps in the foregoing method embodiments are performed. The memory (storage medium) includes: a read-only memory (ROM for short), a RAM, a flash memory, a hard disk, a solid-state drive, a magnetic tape, a floppy disk, an optical disc, and any combination thereof.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

1-20. (canceled)

21. A method comprising:
obtaining, by a terminal device, resource configuration information, wherein the resource configuration information indicates a resource for the terminal device to use to send a scheduling request, and the resource is allocated for transmitting a physical random access channel; and
sending, by the terminal device, the scheduling request to a network device on the resource indicated by the resource configuration information, the scheduling request requesting to send an amount of uplink data by the terminal device to the network device, and the scheduling request carrying a sequence that has a preset correspondence with the amount of uplink data that is requested to be sent by the terminal device to the network device.

22. The method according to claim 21, wherein the scheduling request comprises a plurality of symbol groups in a time domain, and each symbol group comprises a cyclic prefix and at least one symbol.

23. The method according to claim 21, wherein the scheduling request is sent in a single-carrier frequency-hopping manner.

24. The method according to claim 21, wherein the scheduling request comprises a plurality of sequences carried on a plurality of symbol groups with each symbol group comprising symbols, sequences carried on different symbol groups of the scheduling request are different, and sequences carried on different symbols in a same symbol group are same.

25. The method according to claim 21, wherein the scheduling request is send in a single-carrier manner, and the scheduling request comprises a plurality of sequences transmitted respectively in a plurality of symbol groups during a repeated sending period of the scheduling request, the plurality of symbol groups located at a same subcarrier location, and the scheduling request being sent in a sending period that comprises at least one repeated sending period of the scheduling request.

26. The method according to claim 25, wherein sequences carried on different symbol groups are different, and sequences carried on different symbols in a same symbol group are different.

27. The method according to claim 21, wherein obtaining, by the terminal device, the resource configuration information comprises:
receiving, by the terminal device, the resource configuration information sent by the network device; or
obtaining, by the terminal device, the resource configuration information from a local cache, wherein the resource configuration information is configured by the network device for the terminal device when the terminal device is initialized.

28. A terminal device, comprising:
a non-transitory memory storage comprising instructions; and
one or more processors in communication with the memory storage, wherein the instructions, when executed by the one or more processors, cause the terminal device to:
obtain resource configuration information, wherein the resource configuration information indicates a resource for the terminal device to use to send a scheduling request, and the resource is allocated for transmitting a physical random access channel; and
send the scheduling request to a network device on the resource indicated by the resource configuration information obtained, the scheduling request requesting to send an amount of uplink data by the terminal device to the network device, and the scheduling request carrying a sequence that has a preset correspondence with the amount of uplink data that is requested to be sent by the terminal device to the network device.

29. The terminal device according to claim 28, wherein the scheduling request comprises a plurality of symbol groups in a time domain, and each symbol group comprises a cyclic prefix and at least one symbol.

30. The terminal device according to claim 28, wherein the scheduling request is sent in a single-carrier frequency-hopping manner.

31. The terminal device according to claim 28, wherein the scheduling request comprises a plurality of sequences carried on a plurality of symbol groups with each symbol group comprising symbols, sequences carried on different symbol groups of the scheduling request are different, and sequences carried on different symbols in a same symbol group are same.

32. The terminal device according to claim 28, wherein the scheduling request is sent in a single-carrier manner, and the scheduling request comprises a plurality of sequences transmitted respectively in a plurality of symbol groups during a repeated sending period of the scheduling request, the plurality of symbol groups located at a same subcarrier location, and the scheduling request being sent in a sending period that comprises at least one repeated sending period of the scheduling request.

33. The terminal device according to claim 32, wherein sequences carried on different symbol groups are different, and sequences carried on different symbols in a same symbol group are different.

34. The terminal device according to claim 28, wherein the instructions, when executed by the one or more processors, cause the terminal device to further:
receive the resource configuration information sent by the network device; or
obtain the resource configuration information from a local cache, wherein the resource configuration information is configured by the network device for the terminal device when the terminal device is initialized.

35. A non-transitory computer readable medium storing program codes for use by a terminal device, wherein the program codes comprise instructions for:
obtaining resource configuration information, wherein the resource configuration information indicates a resource for the terminal device to use to send a scheduling request, and the resource is allocated for transmitting a physical random access channel; and
sending the scheduling request to a network device on the resource indicated by the resource configuration information, the scheduling request requesting to send an amount of uplink data by the terminal device to the network device, and the scheduling request carrying a sequence that has a preset correspondence with the amount of uplink data that is requested to be sent by the terminal device to the network device.

36. The non-transitory computer readable medium according to claim 35, wherein the scheduling request comprises a plurality of symbol groups in a time domain, and each symbol group comprises a cyclic prefix and at least one symbol.

37. The non-transitory computer readable medium according to claim 35, wherein the scheduling request is sent in a single-carrier frequency-hopping manner.

38. The non-transitory computer readable medium according to claim 35, wherein the scheduling request comprises a plurality of sequences carried on a plurality of symbol groups with each symbol group comprising symbols, sequences carried on different symbol groups of the scheduling request are different, and sequences carried on different symbols in a same symbol group are same.

39. The non-transitory computer readable medium according to claim 35, wherein the scheduling request is sent in a single-carrier manner, and the scheduling request comprises a plurality of sequences transmitted respectively in a plurality of symbol groups during a repeated sending period of the scheduling request, the plurality of symbol groups located at a same subcarrier location, and the scheduling request being sent in a sending period that comprises at least one repeated sending period of the scheduling request.

40. The non-transitory computer readable medium according to claim 39, wherein sequences carried on different symbol groups are different, and sequences carried on different symbols in a same symbol group are different.
